(19) United States
(12) Patent Application Publication
(10) Pub. No.: US 2016/0260462 A1
(43) Pub. Date: Sep. 8, 2016

(54) HARD DISK DRIVE CARRIER

(71) Applicant: HEWLETT-PACKARD ENTERPRISE DEVELOPMENT LP, Houston, TX (US)

(72) Inventors: Peter Raymond Szczesniak, Houston, TX (US); Minh H Nguyen, Katy, TX (US)

(21) Appl. No.: 15/029,490

(22) PCT Filed: Nov. 26, 2013
(86) PCT No.: PCT/US2013/071863

§ 371 Date: Apr. 14, 2016

(51) Int. Cl. G11B 33/12; G11B 33/02

(52) U.S. Cl. CPC G11B 33/124; G11B 33/022

(57) ABSTRACT

A hard disk drive apparatus is provided herein. The hard disk drive apparatus includes a base and a support member. The base is formed to receive a hard disk drive. The support member is formed to connect to the base. The support member is formed of a pliable material to move into a displaced position when a force is applied.

### BACKGROUND

Computing systems include hard disk drives. The hard disk drives are typically attached to a hard disk drive carrier then inserted into a computing system. For example, a hard disk drive is attached to a hard disk drive carrier and then inserted into a shelf in a computing system where it is connected to other electronic components.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a hard disk drive apparatus according to an example;

FIG. 2 illustrates an exploded view of the hard disk drive apparatus of FIG. 1 according to an example;

FIGS. 3-6 illustrate perspective diagrams of portions of the hard disk drive apparatus of FIG. 1 according to examples;

FIG. 7 illustrates a block diagram of a system according to an example;

FIGS. 8-9C illustrate perspective diagrams of the system of FIG. 7 according to examples; and

FIG. 10 illustrates a flow chart of a method according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Computing system designs determine requirements for components in the computing system. Space, thermal constraints, cost, and ease of use are some factors that determine the type of hard disk drive carriers that are used in a specific computing system. In examples, a hard disk drive apparatus is provided. The hard disk drive apparatus includes a base and a support member. The base is formed to receive a hard disk drive. The support member is formed to connect to the base. The support member is formed of a pliable material that moves into a displaced position when a force is applied. The hard disk drive apparatus does not require any fasteners and is formed using reduced amounts of material. The hard disk drive apparatus also works in confined spaces and provides airflow around the hard disk drives.

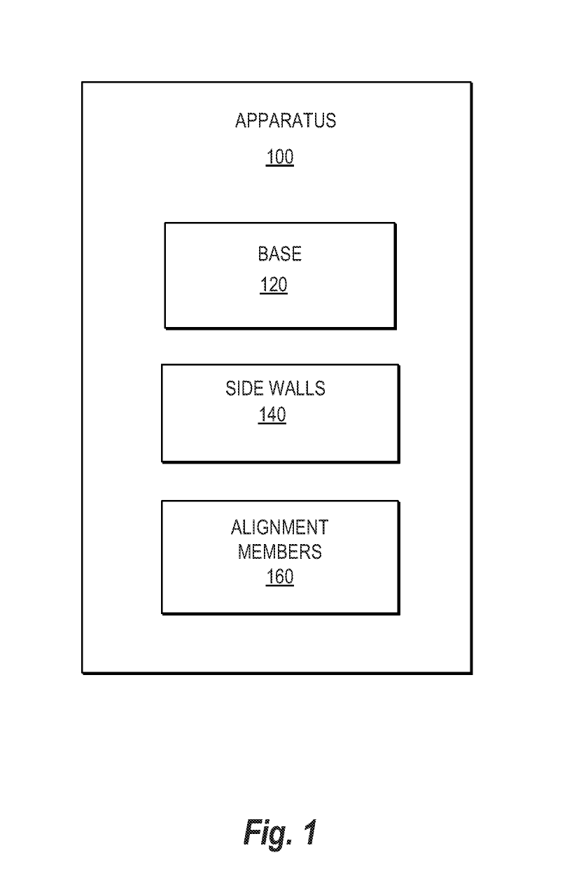

FIG. 1 illustrates a block diagram 100 of a hard disk drive apparatus according to an example. A hard disk drive apparatus 100 includes a base 120, a pair of side walls 140, and an alignment member 160. The base 120 is formed to receive a hard disk drive. The pair of sidewalls 140 are formed to connect to the base 120. The pair of side walls 140 are formed of a pliable material that moves between an equilibrium position and a displaced position. The pair of side walls 140 remain in the equilibrium position when no force is applied. The pair of side walls 140 to move into the displaced position when a force is applied. The set of alignment members 160 to align the pair of side walls on the base 120.

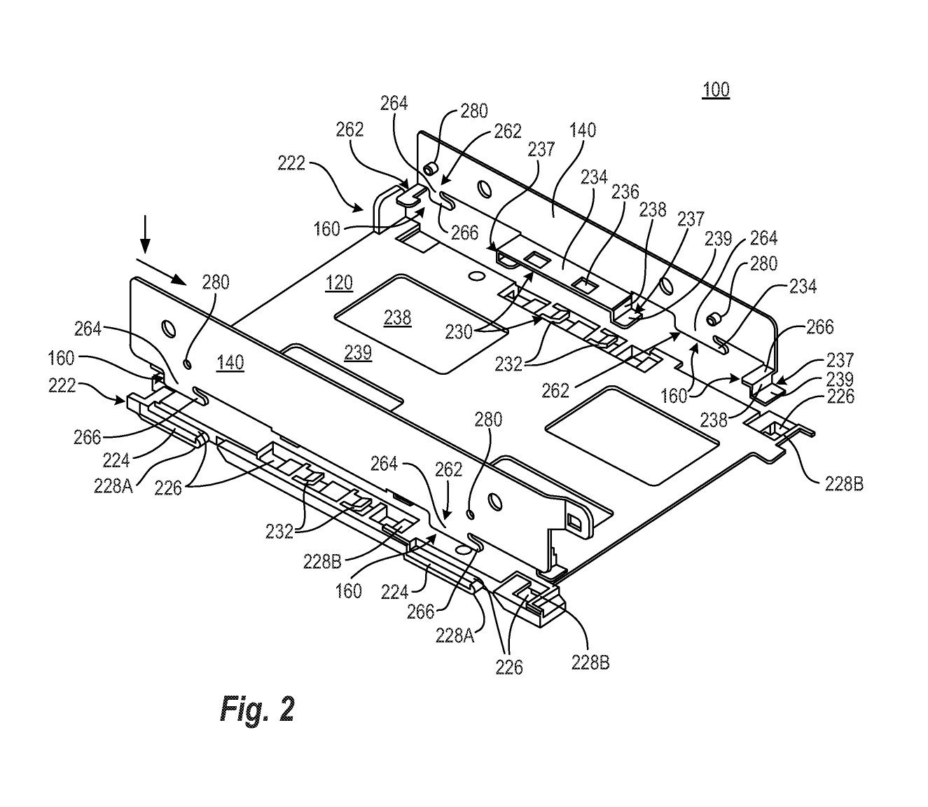

FIG. 2 illustrates an exploded view of the hard disk drive apparatus 100 of FIG. 1 according to an example. The hard disk drive apparatus 100 may include for example, a hard disk drive carrier. The hard disk drive apparatus 100 includes the base 120, the pair of side walls 140, and the alignment member 160 as described in FIG. 1. The base 120 is illustrated of a planar member formed to receive a hard disk drive. The base 120 may be formed of, for example, a thin sheet metal.

The pair of side walls 140 are each illustrated as a planar member that is formed to mate with the base 120, such that the base 120 is approximately perpendicular to both of the pair of side walls 140. The pair of side walls 140 are approximately parallel to one another and may be formed of plastic, for example. The pair of side wall 140 form a support structure for the hard disk drive.

The set of alignment members 160 are illustrated as formed in the side walls 140 and formed to connect to the base 120 along a horizontal edge 222. For example, the set of alignment members 160 may include an L shaped protrusion 262 illustrated to include a first protrusion member 264 and a second protrusion member 266. The alignment members 160 may also include additional alignment features, such as a lock alignment member 237 further described below.

The hard disk drive apparatus 100 further includes a mounting member 280 to engage with a hard disk drive when the hard disk drive is inserted therein. The mounting member 280 may include, for example, a rod and/or a protrusion. The rod or protrusion may extend from at least one of the pair of side walls 140 and mate with an aperture or mating member on the hard disk drive.

The hard disk drive apparatus 100 further includes a track 224 to receive the pair of side walls 140. For example, the track 224 may be formed in the base 120 or attached to the base 120. The track 224 may further include grooves 226 to align and engage with alignment member 160. In an example, the L shaped protrusion 262 slides along the grooves 226 to align the side wall 140 and engage with the base 120. The hard disk drive apparatus 100 may further include a limiter 228 to control movement between the base 120 and the pair of side walls 140. For example, the limiter 228 controls movement along the track 224 and control engagement between base 120 and the alignment member 160. The movement controlled by the limiter 228 may include horizontal movement, vertical movement, or a combination thereof. The limiter 228 may include any combination of protrusions 228A along the track 224 and/or apertures 228B in the track 224 that align and guide the alignment members 160.

The hard disk drive apparatus 100 further includes a lock mechanism 230 to connect the pair of side walls 140 and the base 120. For example, the lock mechanism 230 includes an interlocking protrusion 232 on the base 120 and a lock aperture 236 formed in the planar member 234. The interlocking protrusion 232 is illustrated as extending from the base 120 to engage with at least one of the pair of side walls 140. The locking portion of the side wall 140 includes a planar member 234 extending from the side wall 140 perpendicular thereto. The lock mechanism 230 may be secured through the engagement between the limiter 228 in the base 120 and the lock aperture 236. The lock mechanism 230 may further include lock alignment members 237. For example, the lock alignment members 237 may include a first lock member 238 extending from the planar member 234 perpendicular thereto and a second lock member 239 extending from the first lock member 238 perpendicular thereto or parallel to the planar member 234.

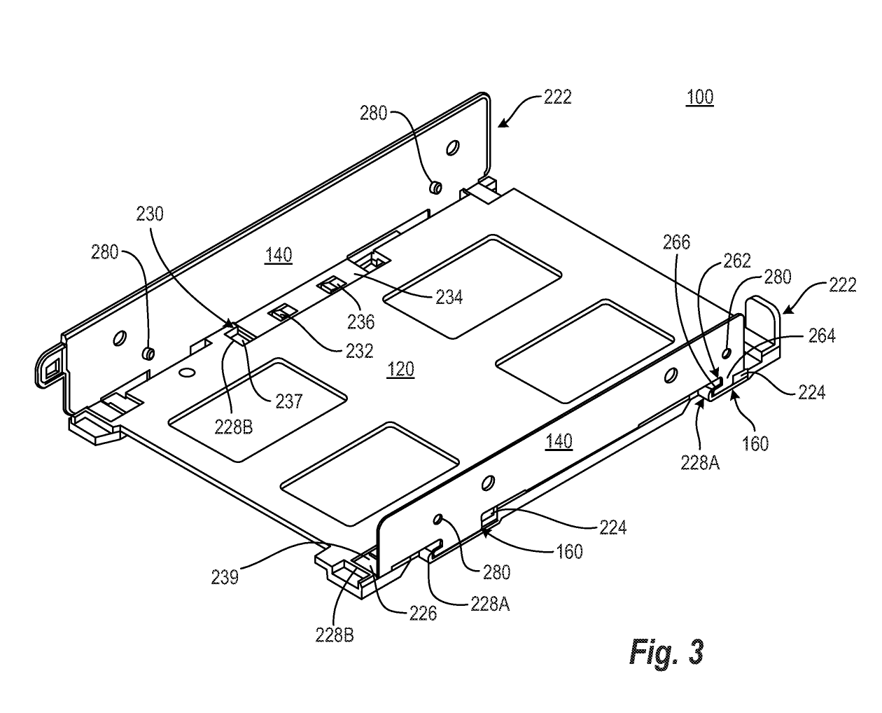

FIGS. 3-6 illustrate perspective diagrams of portions of the hard disk drive apparatus 100 of FIG. 1 according to examples. FIG. 3 illustrates an assembled view of the hard disk drive apparatus 100. Referring to FIG. 3, the base 120 includes a track 224 with grooves 226 along two opposing edges, referred to as the horizontal edges 222. The pair of side walls 140 are illustrated as approximately parallel to one another and approximately perpendicular to the base 120. The pair of side walls 140 connect to the base 120 using alignment members 160. For example, the L shaped protrusion 262 slides along the grooves 226 to align the side wall 140 and engage with the base 120. At least one limiter 228 may be used to control movement of the alignment members 160 along the track 224. The lock mechanism 230 is also illustrated to secure the pair of side walls 140 to the base 120. The lock mechanism 230 includes the interlocking protrusion 232 on the base 120 engaged with the lock aperture 236 formed in the side wall 140.

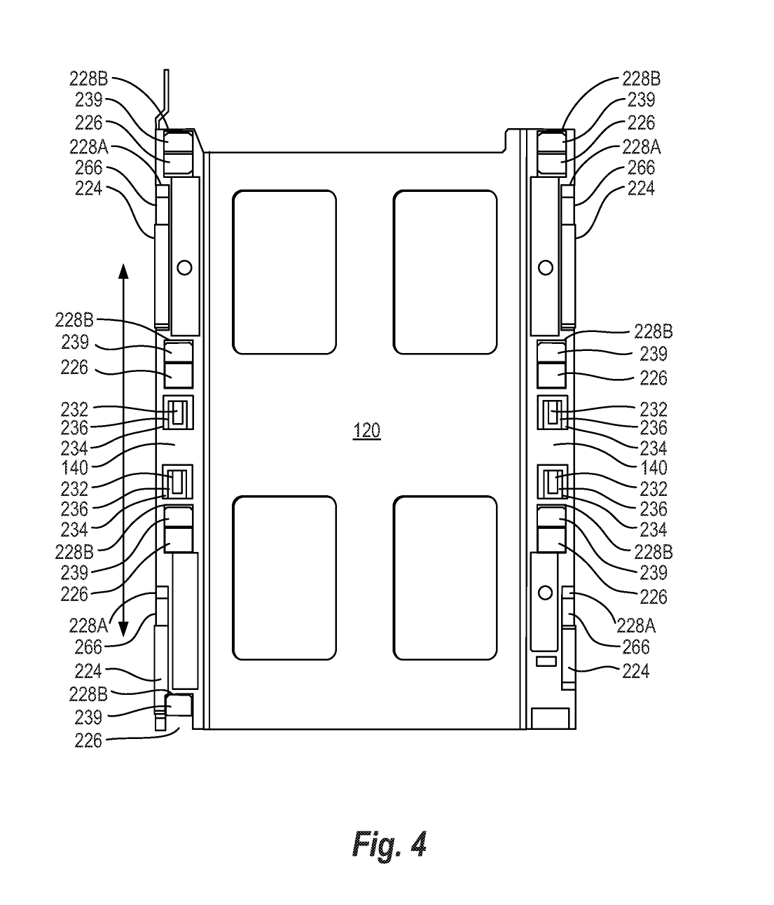

FIG. 4 illustrates a bottom view of the base 120. Referring to FIG. 4, the base 120 is illustrated with the bottom of the track 224, the limiters 228, and the interlocking protrusions 232 visible. The bottom view also illustrates portions of the pair of wall members 140. For example, the bottom side of the second protrusion member 266 in the track 224 and a second lock member 239 in the groove 226 are illustrated. The movement of the second protrusion member 266 may be limited by a limiter 228A, and the movement of the second lock member 239 may be limited by a limiter 228B. The lock mechanism 230 is also illustrated. The portions of the lock mechanism 230 illustrated include the interlocking protrusion 232 on the base and the planar member 234 and the lock aperture 236 on the side wall 140. The planar member 234 and the lock aperture 236 engage with the interlocking protrusion 232 to connect the side wall 140 to the base 120 and hold the L shaped protrusions 262 and the lock alignment members 237 in place.

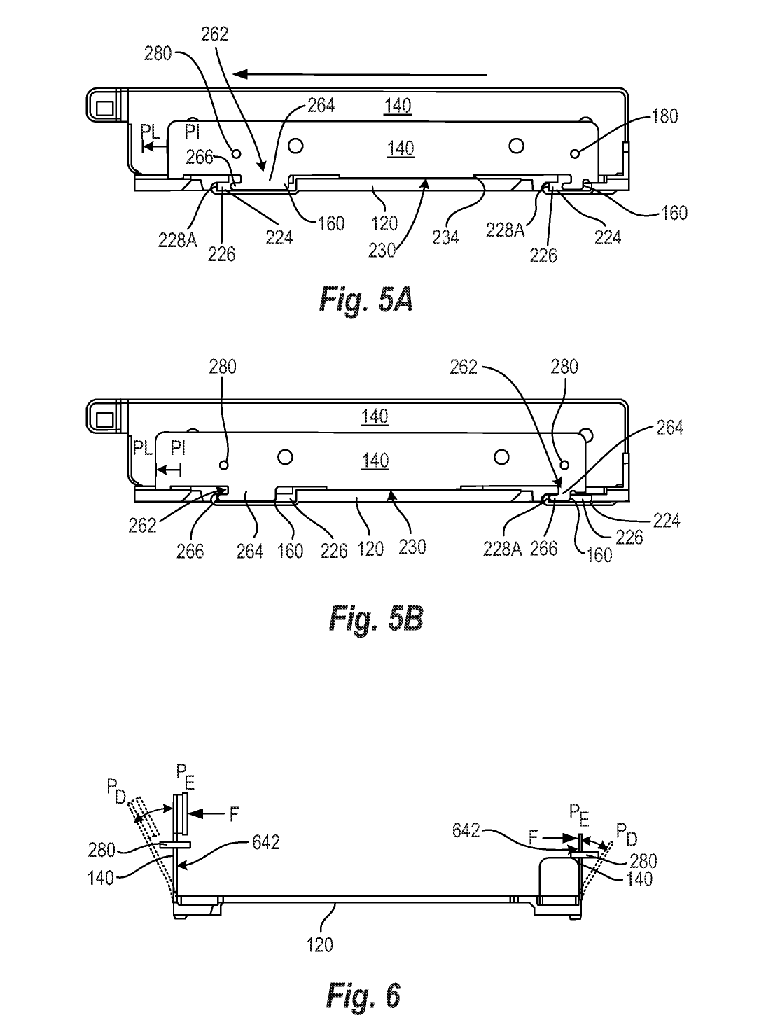

FIGS. 5A-5B illustrate a side view of the hard disk drive apparatus 100. The side views illustrate the motion of the pair of side walls 140 when they are assembled. Referring to FIG. 5A, one of the pair of side walls 140 is illustrated contacting the base 120 in an initial position, P_{I}. The alignment members 160 align the side wall 140 on the base 120 and engaged with the grooves 226 to confirm alignment. The grooves 226 are illustrated as formed in the base 120. The alignment members 160 have space to move horizontally along the base 120 in position P_{I}, and the lock mechanism 230 is not engaged.

Once the side wall 140 is aligned and positioned along the base 120, the side wall 140 may slide horizontally into a locked position, P_{L}. As the side wall 140 slides or moves into the locked position, P_{L}, the alignment members 160 move along the track 224 until a limiter 228 is met and the lock mechanism engages to secure the side wall 140 and the base 120 together, as illustrated in FIG. 4B. In the locked position, P_{L}, the hard disk drive apparatus 100 is ready to receive a hard disk drive.

FIG. 6 illustrates the motion of the pair of side walls 140 according to an example. When the hard disk drive apparatus 100 is assembled and prior to receiving a hard disk drive, the pair of side walls 140 remain at an equilibrium position, P_{E}, or resting state, in which the pair of side walls 140 are approximately parallel to one another and approximately perpendicular to the base 120. The dimensions of the hard disk drive apparatus 100 are approximately the same as the dimensions of the hard disk drive that the hard disk drive apparatus 100 is intended to receive and hold.

The hard disk drive apparatus 100 is formed such that the pair of side walls 140 are formed of a pliable material that bend outwards, The pair of side walls 140 bend outward from the equilibrium position, P_{E}, to a displaced position P_{D}, when a force is applied to an inner surface 642 of the side walls 140. In the displaced position, P_{D}, the hard disk drive apparatus 100 forms an opening for the hard disk drive to be inserted therein. FIG. 6 further illustrates the mounting member 280 as a pair of rods extending through the pair of side walls. The mounting member 280 to engage with the hard disk drive when the hard disk drive is inserted therein.

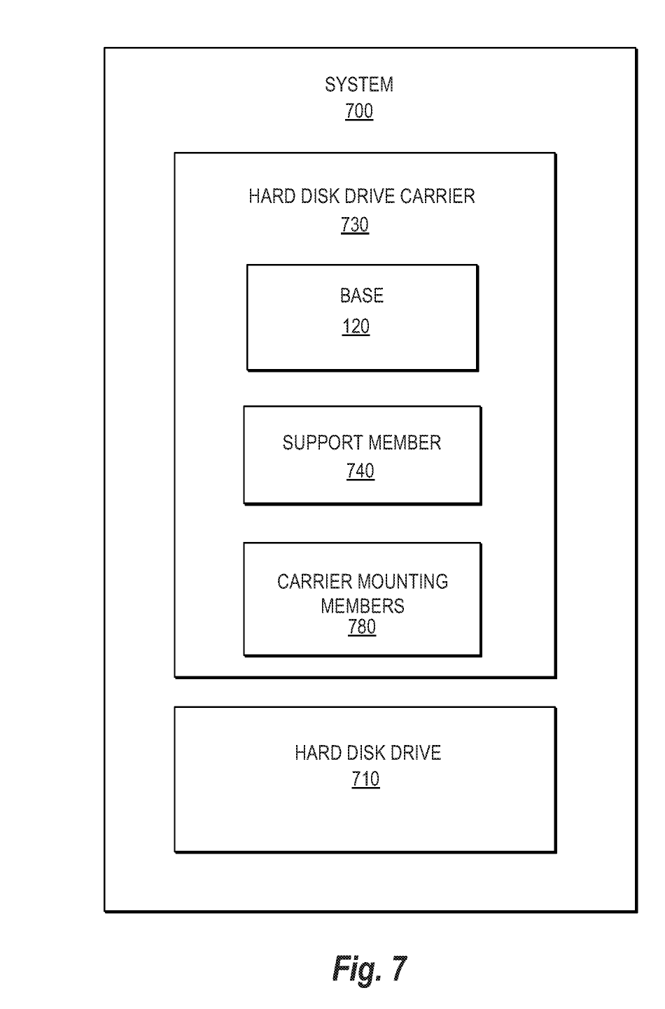

FIG. 7 illustrates a block diagram of a system 700 according to an example. The system 700 includes a hard disk drive 710 and a hard disk drive carrier 730 to receive the hard disk drive 710. The hard disk drive carrier 730 includes a base 120, a support member 740, and a carrier mounting member 780. The base 120 is formed to receive the hard disk drive 710. The support member 740 is formed to connect to the base 120. The support member 740 is formed of a pliable material to move into a displaced position when a force is applied. For example, the support member 740 may include a pair of side walls 140 as illustrated with reference to FIGS. 1-6. The carrier mounting member 780 to mate with the hard disk drive 710 and hold the hard disk drive 710 in place. The carrier mounting member 780 may include, for example, a rod and/or a protrusion extending from the support member 740, The mounting member 780 may be a separate component of the hard disk drive carrier 730 or formed in the support member 740.

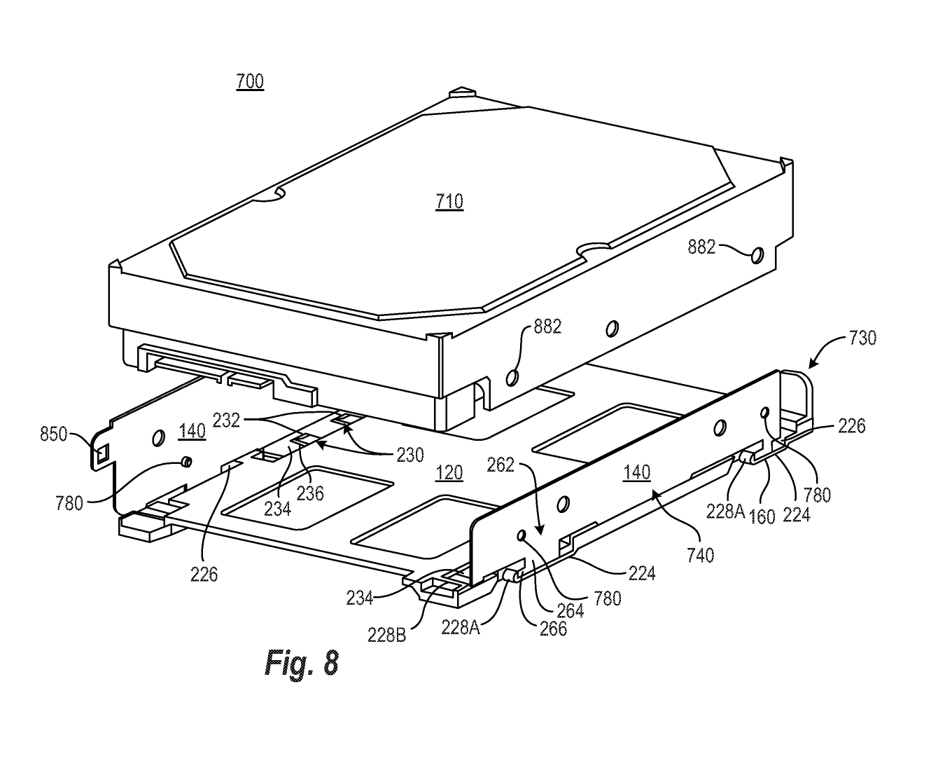

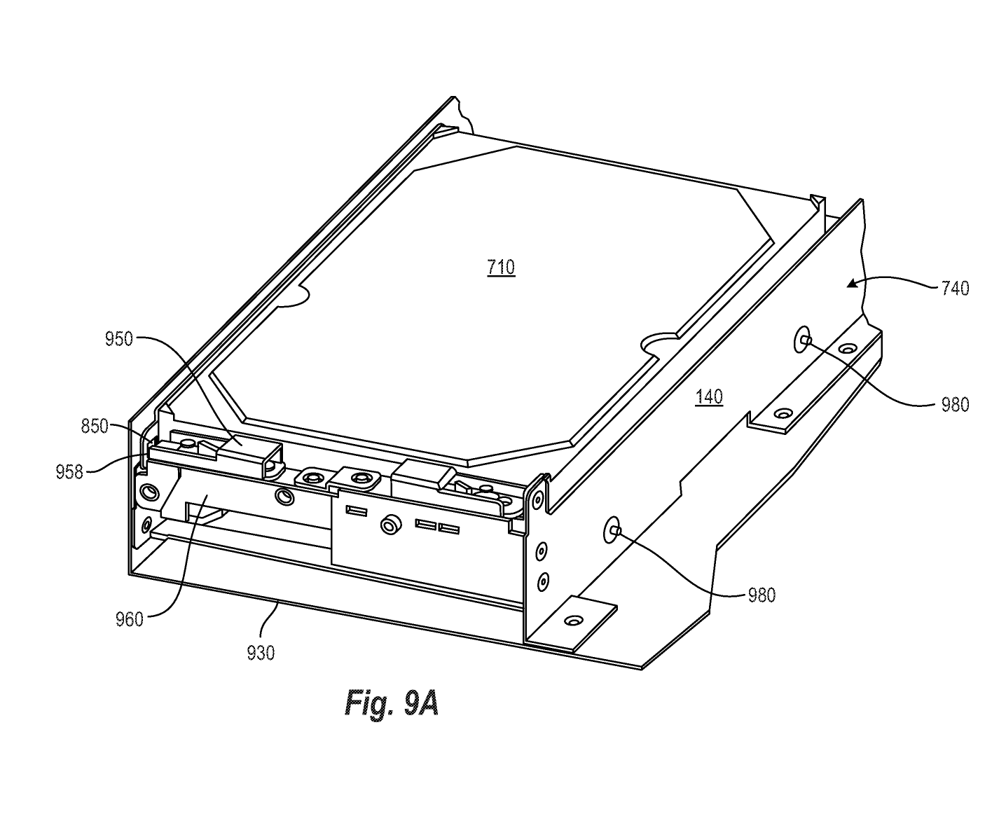

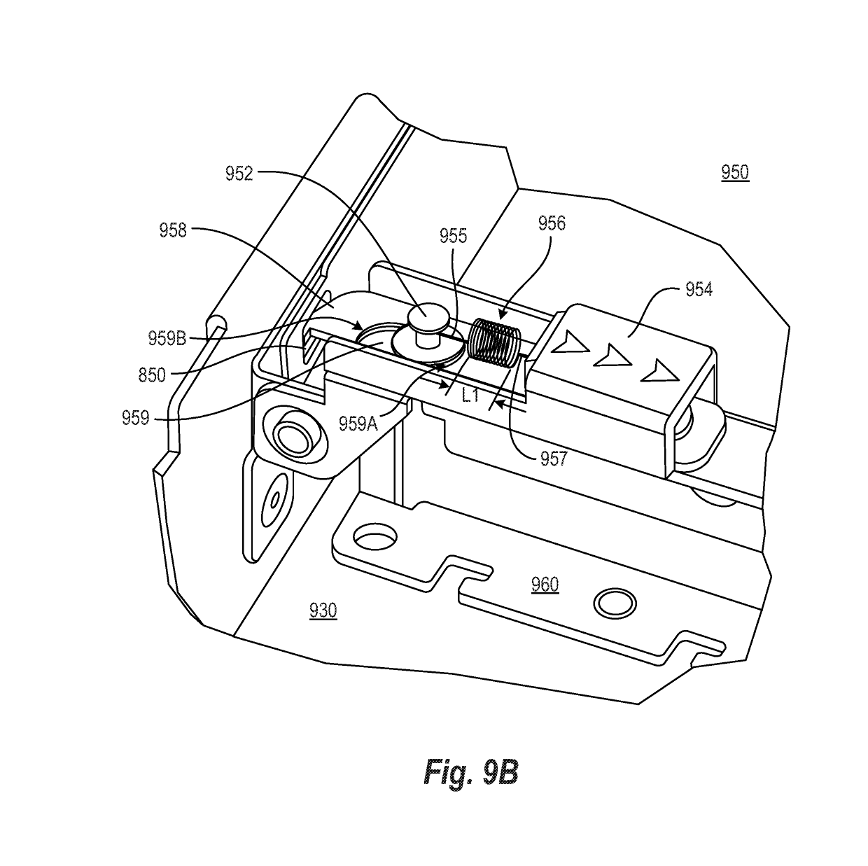

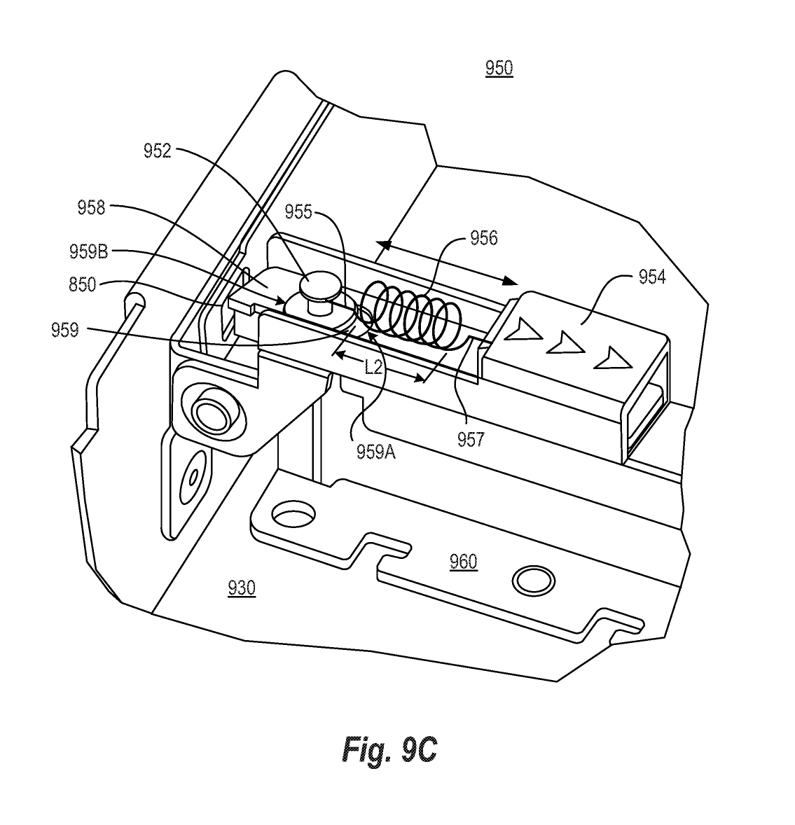

FIGS. 8-9C illustrate perspective diagrams of the system of FIG. 7 according to examples. Referring to FIG. 8, the hard disk drive 710 and the hard disk drive carrier 730 are illustrated prior to assembly. The hard disk drive carrier 730 may include, or example, the hard disk drive apparatus 100 of FIG. 3 above.

The hard disk drive carrier 730 includes the base 120, the support member 740, and a set of alignment members 160 extending from the support member 740. The set of alignment members 160 include one or a combination of the L shaped protrusions 262, the lock alignment members 237, and/or the lock mechanism 230 that align and hold the hard disk drive apparatus together, as illustrated in FIGS. 1-6. The support member 740 also includes a latch receiving member 850. The latch receiving member 850 is formed to receive a latch that holds or secures the hard disk drive carrier 730 to a shelf, FIG. 8 illustrates an example of the latch receiving member 850 as an aperture formed in the support member 740.

The hard disk drive 710 may include a drive mounting member 882 to mate with the carrier mounting member(s) 780 and secure the hard disk drive 710 in place. For example, the drive mounting member 882 may include at least one aperture formed in the hard disk drive 710 to secure and align the hard disk drive 710 in the hard disk drive carrier 730. The drive mounting member 882 and the carrier mounting members 780 secure the hard disk drive 710 in the carrier by engaging with one another as the drive mounting members 882 receive the carrier mounting members 780.

For example, the carrier mounting member 780 includes at least one of a protrusion or a rod. Referring to FIG. 8, the protrusion extends from the support member 740 and connects to the drive mounting member 882, illustrated as an aperture in the hard disk drive 710. In an alternate example, FIG. 9A illustrates the carrier mounting member 780 as a rod that extends through the support member 740 to connect the hard disk drive 710 via the drive mounting member 882, such as an aperture similar to the aperture illustrated in FIG. 8. The drive mounting member 882 and/or the carrier mounting member 780 may further include threads and/or other fastening members to form a connection between the drive mounting member 882 and the carrier mounting member 780.

Referring to FIG. 9A, the system 700 is illustrated in an assembled position. The system 700 includes a shelf 930 that the hard disk drive carrier 730 is attached to. The hard disk drive and the hard disk drive carrier 730 may be connected to the shelf using a latch 950. The latch 950 may be connected to the hard disk drive carrier 730, for example, via a latch receiving member 850 illustrated in FIG. 8. The latch 950 to move between an engaged position, as illustrated in FIG. 9B, and an unengaged position, as illustrated in FIG. 9C. in the engaged position, the latch 950 secures the hard disk drive carrier 730 to the shelf 930 and in the unengaged position, the latch 950 releases the hard disk drive carrier 730 from the shelf.

Referring to FIGS. 9B-9C, the latch 950 includes a pin 952, a tab 954, a resilient member 956, and a hook member 958. The pin 952 is connected to a frame structure 960 that connects to the shelf 930. The tab 954 is connected to the frame structure 960 via the pin 952. The tab 954 is formed to connect to the frame structure 960, such that the tab 954 may move along the frame structure 960.

The hook member 958 is formed to move with the tab 954. For example, the hook member 958 is connected to or attached to the tab 954, such that the hook member 958 and the tab 954 move as a unitary member. The tab member 954 may further include a guide aperture 959 to receive the pin 952 and enable the tab 954 to move in accordance with the guide aperture 959, i.e., the guide aperture 959 may control lateral movement of the tab 954 and hook member 958 such that the hook member 958 and the latch receiving member 850 may move into and between an engaged position and an unengaged position.

The resilient member 956 is connected to the pin 952 on one end and the tab 954 on an opposite end. For example, the resilient member 956 is illustrated as a spring in FIGS. 9B-9C. A first end 955 of the resilient member 956 connected to the pin 952 and a second end 957 of the resilient member 965 connected to the tab 954. When a force is applied to the tab 954, the tab 954 moves the resilient member 956 between an equilibrium state and a displaced state. The resilient member 956 returns to the engaged state when no force is applied.

Referring to FIG. 9B, the latch 950 in the engaged position with the hook member 958 engaged with the latch receiving member 850 and the resilient member 956 in an equilibrium state. In the equilibrium state, the distance between the first end 955 and the second end 957 is L1. The tab 954 movement controls the state of the resilient member 956 and the engagement between the pin 952 and the tab 954 is controlled by the movement of the guide aperture 959. For example, the pin 952 contacts the first edge 959A of the guide aperture 959 when the hook member 958 engages with the latch receiving member 850.

Referring to FIG. 9C, the latch 950 is illustrated in the unengaged position with the hook member 958 out of contact with the latch receiving member 850 and the resilient member 956 in a displaced state. In the displaced state, the distance between the first end 955 and the second end 957 is L2. When the latch 950 is in the unengaged state, the pin 952 contacts the second edge 959B of the guide aperture 959 to separate the hook member 958 from the latch receiving member 850.

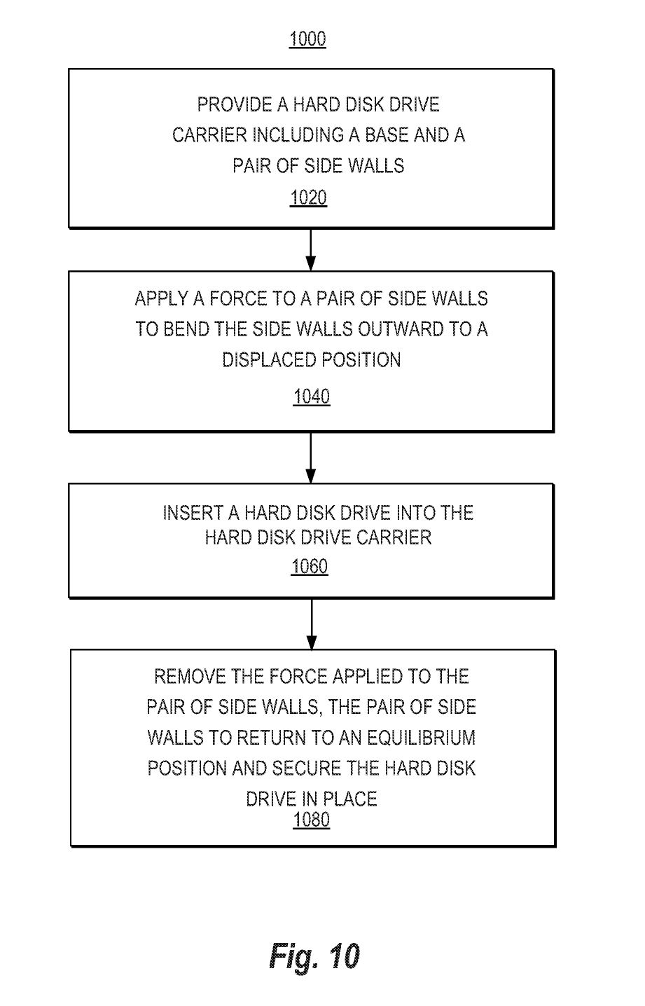

FIG. 10 illustrates a flow chart 1000 of a method according to an example. The method provides a hard disk drive carrier in block 1020. The hard disk drive carrier includes a base and a pair of side wails. The base is formed to receive a hard disk drive. The pair of side walls are formed to connect to the base. The pair of side walls are formed of a pliable material that bends into a displaced position when a force is applied.

In block 1040, a force is applied to the pair of side walls. The force to bend the side walls outward to the displaced position. A hard disk drive is inserted into the hard disk drive carrier in block 1060. The force applied to the pair of side walls is removed in block 1080. Removal of the force enables the pair of side walls to return to an equilibrium position and secure the hard disk drive in place using a mounting member to engage the pair of side walls with the hard disk drive. For example, the carrier mounting members and the drive mounting members may engage with one another.

The hard disk drive carrier with the hard disk drive inserted may be inserted into a shelf. A latch may engage with the hard disk drive carrier, for example, via a latch receiving member on the pair of side walls. The latch to secure the hard disk drive carrier on the shelf. Examples of the latch and system assembled are illustrated in FIGS. 9A-9C.

Although the flow diagram of FIG. 10 illustrates specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A hard disk drive apparatus comprising:
a base formed to receive a hard disk drive
a pair of sidewalls formed to connect to the base, the pair of side walls formed of a pliable material that moves between an equilibrium position and a displaced position, the pair of side walls to move into a displaced position when a force applied; and
a set of alignment members to engage with a hard disk drive.

2. The hard disk drive apparatus of claim 1, wherein the pair of side walls connect to the base along a horizontal edge.

3. The hard disk drive apparatus of claim 1, wherein the set of alignment members form in the side walls.

4. The hard disk drive apparatus of claim 1, wherein the hard disk drive apparatus further comprises a mounting member extending from the side walls.

5. The hard disk drive apparatus of claim 1, wherein the pair of side walls are form to bend outward to the displaced position

6. The hard disk drive apparatus of claim 1, further comprising a lock mechanism to connect the pair of side walls and the base.

7. The hard disk drive apparatus of claim 1, further comprising a track to receive the pair of side walls.

8. The hard disk drive apparatus of claim 7, further comprising a limiter to control movement between the base and the pair of side walls.

9. A system comprising:
a hard disk drive;
a hard disk drive carrier including:
a base formed to receive a hard disk drive;
a support member formed to connect to the base, the support member formed of a pliable material, the support member to move into a displaced position when a force is applied;
a carrier mounting member to mate with a hard disk drive.

10. The system of claim 9, wherein hard disk drive includes a drive mounting member to mate with the carrier mounting member.

11. The system of claim 9, wherein the career mounting member comprises a protrusion to connect the hard disk drive to the support member.

12. The system of claim 9, wherein the carrier mounting member comprises a rod extending through the support member to connect the hard disk drive.

13. The system claim 9, further comprising a latch connected to the hard disk drive carrier, the latch to move between an engaged position and an unengaged position, in the engaged position, the latch secures the hard disk drive carrier to a shelf, and in the unengaged position, the latch releases the hard disk drive carrier.

14. The system of claim 13, wherein the support member includes a latch receiving member to receive the latch.

15. A method comprising:
providing a hard disk drive carrier including:
a base formed to receive a hard disk drive; and
a pair of sidewalls formed to connect to the base, the pair of side walls formed of a pliable material, the pair of side walls to bend into a displaced position when a force is applied;
applying a force to the pair of side was to bend the side walls outward to the displaced position;
inserting a hard disk drive into the hard disk drive carrier; and
removing the force applied to the pair of side walls, the pair of side walls to return to an equilibrium position and secure the hard disk drive in place using a mounting member to engage the pair of side walls with the hard disk drive.

15. The system of claim 13, wherein the latch comprises:
a pin to connect to a frame structure
a tab to connect to the frame structure via the pin,
a resilient member connected to the pin on one end and the tab on an opposite end, and
a hook member formed to move with the tab and engage with a latch receiving member.

17. The system of claim 18, wherein the tab is formed to move along the frame structure.

18. The system of claim 18, further comprising a guide aperture to receive the pin and enable the tab to move in accordance with the guide aperture.

19. The system of claim 18, wherein the tab and the hook member move as a unitary member.

20. The system of claim 18, wherein the resilient member comprises a spring.
